(19) United States
(12) Patent Application Publication
(10) Pub. No.: US 2017/0157882 A1
(43) Pub. Date: Jun. 8, 2017

(54) UNINTERRUPTED BAG MAKING AND FOLDING MACHINE

(71) Applicant: COSMO MACHINERY CO., LTD., New Taipei City (TW)

(72) Inventor: Chun Liang Lin, New Taipei City (TW)

(21) Appl. No.: 15/439,934

(22) Filed: Feb. 22, 2017

Related U.S. Application Data
(63) Continuation-in-part of application No. 14/267,062, filed on May 1, 2014.

(51) Int. Cl. B31B 1/00

(52) U.S. Cl. CPC B31B 23/00; B31B 19/10; B31B 19/14; B31B 19/52; B31B 19/64; B31B 2219/022; B31B 2219/143; B31B 2219/145; B31B 2219/2654; B31B 2219/6061; B31B 2237/60; B31B 2219/95

(57) ABSTRACT

An uninterrupted bag making and folding machine includes multiple server power sources electrically connected to a control unit, which instructs a conveyance unit to deliver a film tube through a sealing unit, a perforating unit and a waste breaking device for processing into finished bags, and a folding unit for folding each finished bag to reduce the size for storage. The invention enables the film tube to be continuously delivered at a constant speed and processed through a sealing process, a waste breaking process and a finished bag folding process, accelerating the finished bag fabrication speed and improving the production capacity.

### CROSS-REFERENCE TO RELATED APPLICATION

The present invention is a continuation-in-part of patent application Ser. No. 14/267,062, filed on May 1, 2014.

### BACKGROUND OF THE INVENTION

1. Field of the Invention

The present invention relates to plastic film tube packaging technology and more particularly, to an uninterrupted bag making and folding machine.

2. Description of the Related Art

Many uninterrupted bag making and folding machines are known for processing a plastic wrap into rolls. For example, U.S. Ser. No. 14/267,062, invented by the present inventor, discloses an uninterrupted bag making machine, which, as illustrated in FIGS. 4, 5 and 6, includes a conveyance unit, a conveyance unit driving means, a sealing unit having sealing assemblies, a sealing unit driving means, a perforating unit having a cutting device, a perforating unit, a perforating unit driving means, a breaking unit, and a control unit. With the conveyance unit, a film tube A is conveyed to pass through the sealing unit, the perforating unit, and the breaking unit. Furthermore, with the control unit in cooperation with various driving means, the sealing assemblies can be moved in the direction of the film tube being moved, and the cutting device of the perforating unit is rotated in synchronous with the film tube being moved. As such, the film tube can be processed with sealing operations, perforating operations, and breaking operations at predetermined locations along the film tube without an interruption, so that the production rate and capacity can be increased. However, this design of uninterrupted bag making machine is still not satisfactory in function. According to this design, the upper and lower sealing assemblies have a complicated structure, and must be reciprocated following the film tube moving direction at an equal speed to seal the film tube A into a series of bags. It is difficult to control the sealing precision and stability. Further, after the fabrication, an additional finished bag folding procedure is necessary for further packaging and delivery.

### SUMMARY OF THE INVENTION

The present invention has been accomplished under the circumstances in view. It is therefore one object of the present invention to provide an uninterrupted bag making and folding machine, which enables a film tube to be processed into a series of finished bags when it is been continuously delivered at a constant speed, accelerating the fabrication speed.

It is another object of the present invention to provide an uninterrupted bag making and folding machine, which enables the film tube to be continuously delivered at a constant speed and processed through a sealing process, a waste breaking process and a finished bag folding process, saving finished bag storage space, accelerating the fabrication speed and improving the production capacity.

To achieve these and other objects of the present invention, an uninterrupted bag making and folding machine comprises, a plurality of conveyer rollers, a position sensing unit, a sealing unit, a pair of reciprocating wheels, a transmission means, a reciprocating server power source, a third nip roller set, a third server power source, a perforating unit and a breaking unit. The conveyance unit is adapted for conveying a film tube. The conveyer rollers are arranged over the uninterrupted bag making and folding machine to assist conveyance of a film tube for processing. The position sensing unit is disposed downstream of the conveyance unit for detecting the travel distance of the film tube to mate with a predetermined process distance. The sealing unit is disposed downstream of the position sensing unit, comprising a reciprocating conveyer, an upper sealing assembly, a lower sealing assembly, a first nip roller set, a first server power source, a second nip roller set, a second server power source, an upper sealing assembly server power source and a heating unit. The first server power source is adapted for moving the first nip roller set. The second server power source is adapted for moving the second nip roller set. The upper sealing assembly server power source is adapted for moving the upper sealing assembly up and down. The heating unit is adapted for heating the upper sealing assembly and/or the lower sealing assembly. The reciprocating conveyer comprises a pair of rails arranged in parallel, and a pair of sliding blocks arranged in parallel and respectively and slidably coupled to the rails. The reciprocating wheels are arranged in parallel and respectively rotatably coupled to the sliding blocks for enabling the film tube to be delivered above the reciprocating wheels. The reciprocating wheels are disposed below the upper sealing assembly and above the lower sealing assembly. The reciprocating server power source is adapted for driving the transmission means to move the sliding block and the reciprocating wheel forward or backward. The third server power source is disposed downstream of the sealing unit, and adapted for rotating the third nip roller set. The perforating unit is disposed downstream of the third nip roller set, and adapted for processing the film tube to form a perforated portion thereon. The breaking unit is disposed downstream of the film tube for breaking the perforated portion to obtain a finished bag.

Preferably, the uninterrupted bag making and folding machine further comprises a folding unit. The folding unit comprises a first folding blade, a first folding wheel, a secondary folding wheel, a first folding blade linkage and a first folding blade server power source. The first folding wheel is rotatably abutted against the secondary folding wheel. The first folding blade is vertically movable disposed above the first folding wheel and the secondary folding wheel. The first folding blade linkage has one end thereof rotatably coupled to the first folding blade, and an opposite end thereof rotatably coupled to the first folding blade server power source.

Preferably, the uninterrupted bag making and folding machine further comprises a control unit electrically coupled with the speed control wheel power source, the position sensing unit, the reciprocating server power source, the first server power source, the second server power source, the upper sealing assembly server power source, the third server power source, the fourth server power source, jet blower and waste roller power source of the perforating unit, the fifth server power source and sixth server power source of the breaking unit and the first folding blade server power source, second folding blade server power source, third folding blade server power source and power drive of the folding unit. Thus, the control unit can control the component parts that are electrically coupled thereto to cooperate with one another, enabling the film tube to be moved in the predetermined direction at a constant speed relative to the roller die cutter of the perforating unit and properly treated through a sealing process and a waste breaking process where the waste breaking device imparts an air pressure to break the waste off the film tube for enabling an individual finished bag to be separated from the rest of the film tube through the perforated portion and then properly folded up.

### BRIEF DESCRIPTION OF THE DRAWINGS

FIG. 1A is a schematic side view of a front-end part of an uninterrupted bag making and folding machine in accordance with the present invention.

FIG. 1B is a schematic side view of a back-end part of the uninterrupted bag making and folding machine in accordance with the present invention.

FIG. 2 is an oblique top elevational view of the conveyance unit of the uninterrupted bag making and folding machine in accordance with the present invention.

FIG. 3 is an oblique top elevational view of the first side guide device of the uninterrupted bag making and folding machine in accordance with the present invention.

FIG. 4 is an oblique top elevational view of the first film tube tensioner of the uninterrupted bag making and folding machine in accordance with the present invention.

FIG. 5 is an oblique top elevational view of the sealing unit of the uninterrupted bag making and folding machine in accordance with the present invention.

FIG. 6 is an oblique top elevational view of the second side guide device of the uninterrupted bag making and folding machine in accordance with the present invention.

FIG. 7 is an oblique top elevational view of the perforating unit and waste roller of the uninterrupted bag making and folding machine in accordance with the present invention.

FIG. 8 is an exploded view of the perforating unit of the uninterrupted bag making and folding machine in accordance with the present invention.

FIG. 9 is an oblique top elevational view of a part of an alternate form of the uninterrupted bag making and folding machine in accordance with the present invention, illustrating two perforating units arranged together.

FIG. 10 is a schematic elevational view of the present invention, illustrating the film tube delivered through the first film tube tensioner and the breaking unit.

FIG. 11A is a schematic side view of the present invention, illustrating the first folding blade of the folding unit moved in the primary finished bag folding operation.

FIG. 11B is a schematic side view of the present invention, illustrating the second folding blade of the folding unit moved in the secondary finished bag folding operation.

FIG. 11C is a schematic side view of the present invention, illustrating the third folding blade of the folding unit moved in the third time finished bag folding operation.

FIG. 12A is an oblique top elevational view of the first folding blade and second folding blade of the folding unit of the uninterrupted bag making and folding machine in accordance with the present invention.

FIG. 12B is an oblique top elevational view of the third folding blade of the folding unit of the uninterrupted bag making and folding machine in accordance with the present invention.

FIG. 13A corresponds to FIG. 12A when viewed from another angle.

FIG. 13B is a schematic elevational operational view of the present invention, illustrating the third folding blade of the folding unit moved in between the fourth folding wheel and the fifth folding wheel.

### DETAILED DESCRIPTION OF THE PREFERRED EMBODIMENT

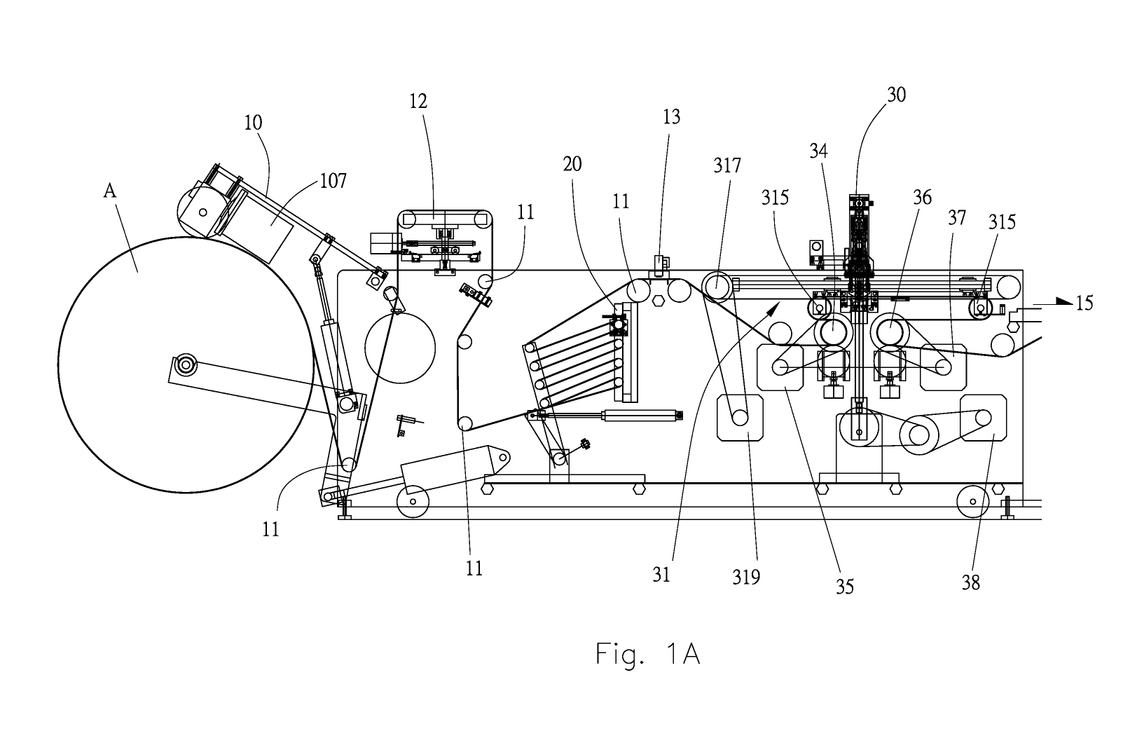

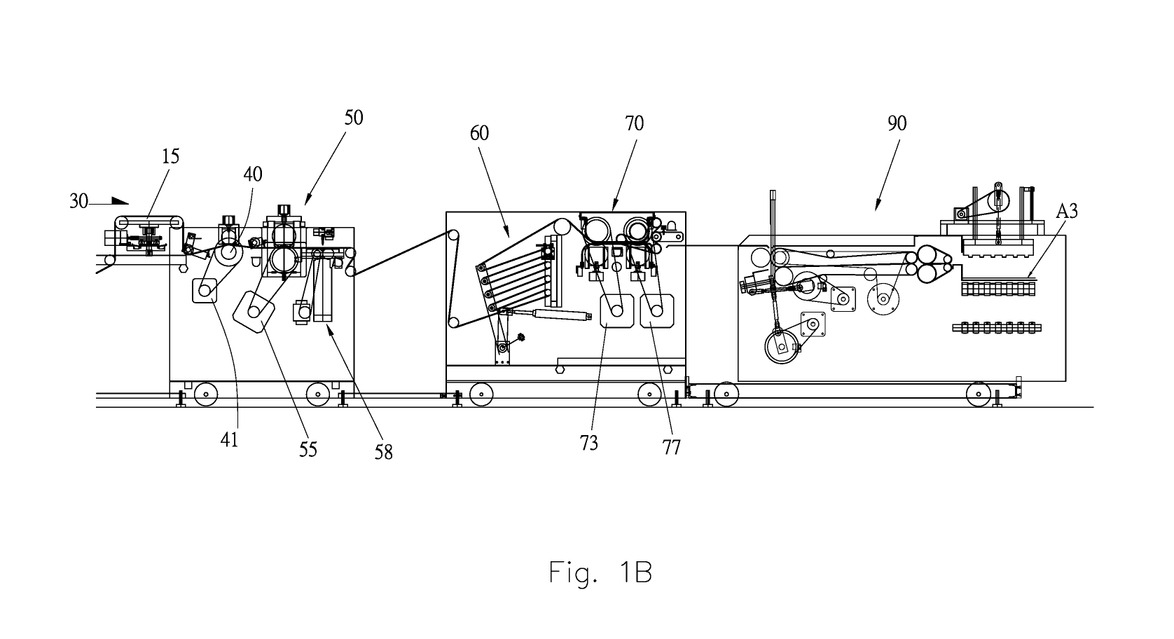

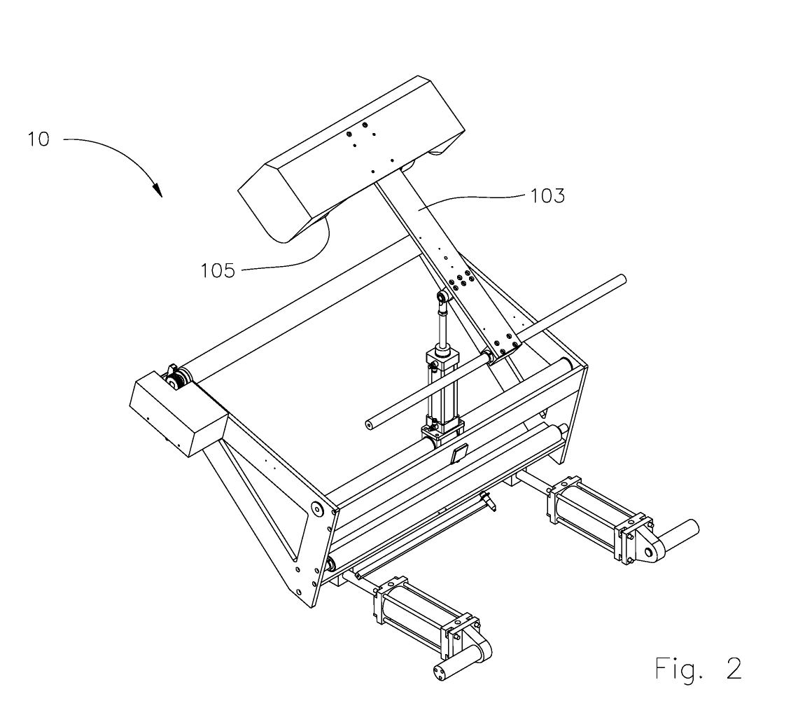

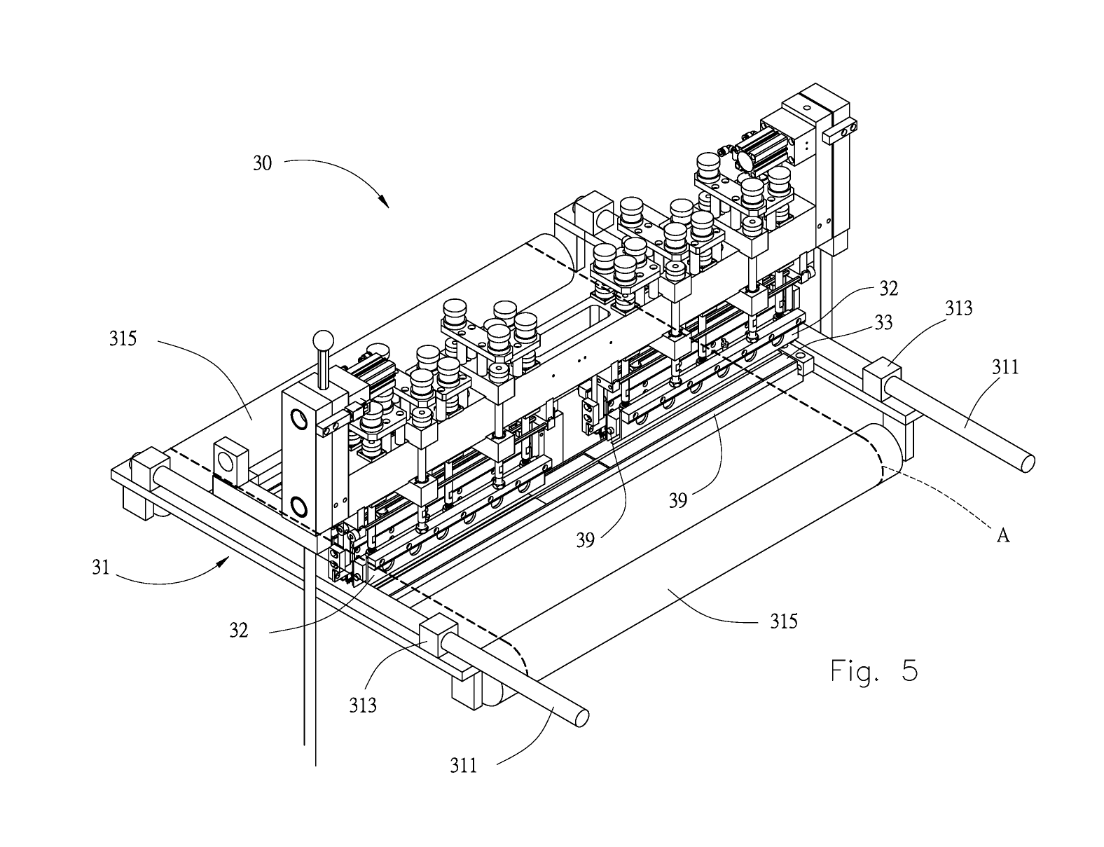

Referring to FIGS. 1A, 1B, 2, 5, 7 and 10, an uninterrupted bag making and folding machine in accordance with the present invention is disclosed. The uninterrupted bag making and folding machine comprises a conveyance unit 10 for conveying a film tube (A), a plurality of guide rollers 11 arranged over the uninterrupted bag making and folding machine to assist conveyance of the film tube A for processing, a position sensing unit 13 disposed downstream of the conveyance unit 10 for detecting the travel distance of the film tube A to mate with a predetermined process distance, and a sealing unit 30 disposed downstream of the position sensing unit 13. The sealing unit 30 includes a reciprocating conveyer 31, an upper sealing assembly 32, a lower sealing assembly 33, a first nip roller set 34, a first server power source 35, a second nip roller set 36, a second server power source 37, an upper sealing assembly server power source 38, and a heating unit 39 for heating the upper sealing assembly 32 and/or the lower sealing assembly 33. The first server power source 35 is adapted for driving the first nip roller set 34. The second server power source 37 is adapted for driving the second nip roller set 36. The upper sealing assembly server power source 38 is adapted for moving the upper sealing assembly 32 up and down. The heating unit 39 is adapted for heating the upper sealing assembly 32 and/or the lower sealing assembly 33. The reciprocating conveyer 31 includes a pair of rails 311 arranged in parallel, a pair of sliding blocks 313 respectively slidably coupled to the rails 311, and a pair of reciprocating wheels 315 respectively rotatably coupled to the sliding blocks 313. The film tube A is to be delivered over the reciprocating wheels 315. The upper sealing assembly 32 is vertically movably mounted above the reciprocating wheel 315. The lower sealing assembly 33 is mounted below the reciprocating wheel 315. The reciprocating conveyer 31 further includes a transmission means 317 adapted for moving the sliding blocks 313 and the reciprocating wheel 315 forward or backward, and a reciprocating server power source 319 adapted for moving the transmission means 317 forward or backward. The uninterrupted bag making and folding machine further comprises a third nip roller set 40 arranged downstream of the sealing unit 30 for transferring the film tube A, a third server power source 41 arranged downstream of the sealing unit 30 and adapted for driving the third nip roller set 40 to transfer the film tube A, a perforating unit 50 arranged downstream of the third nip roller set 40 for making tiny perforation on the film tube (A) so as to form a perforated portion (A1) thereon, a breaking unit 70 arranged downstream of the perforating unit 50 for breaking the perforated portion (A1) of the film tube (A) made by the breaking unit 50 off the rest of the film tube (A) to form a finished bag A3.

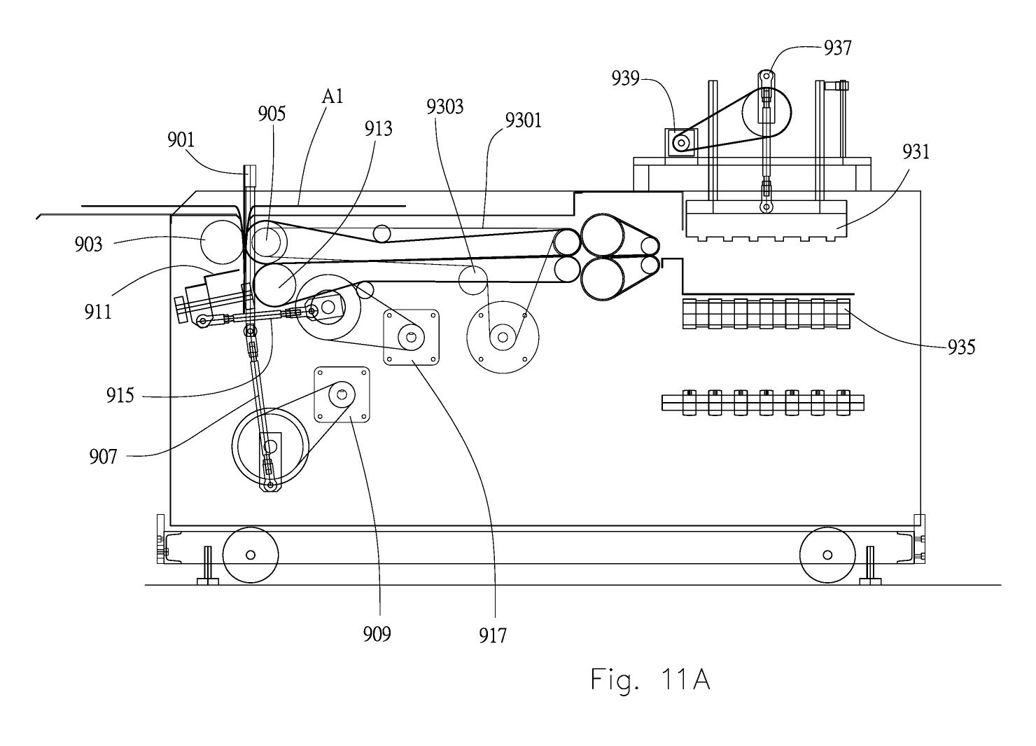

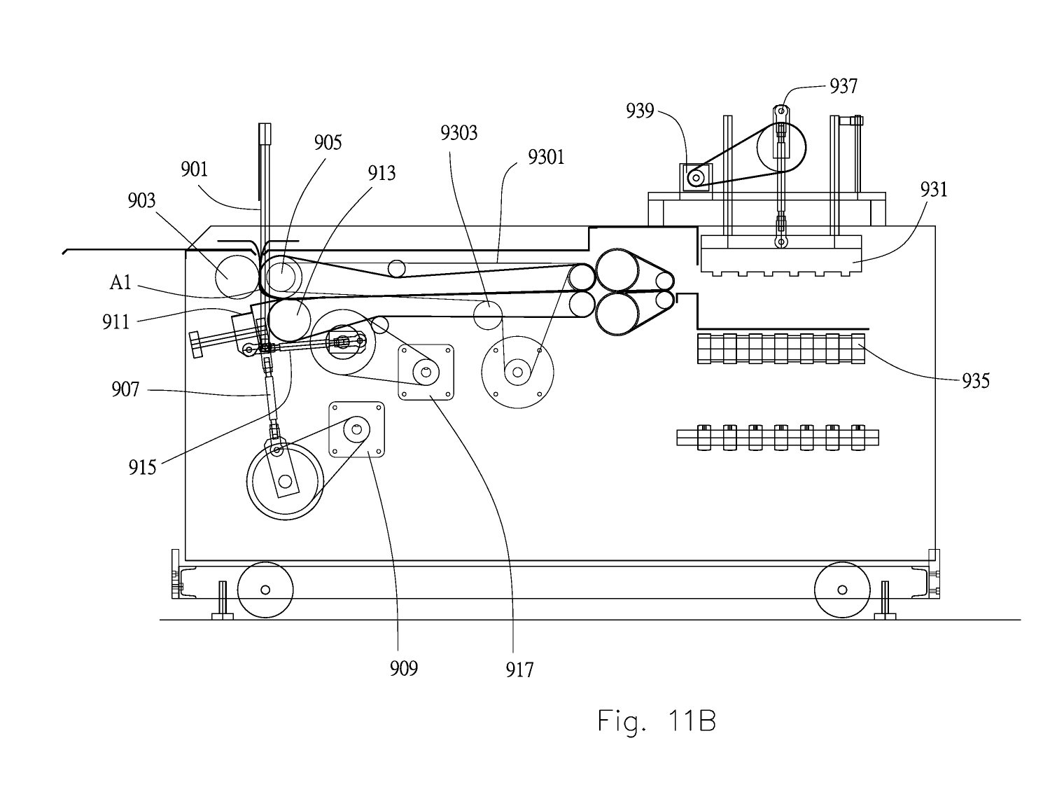

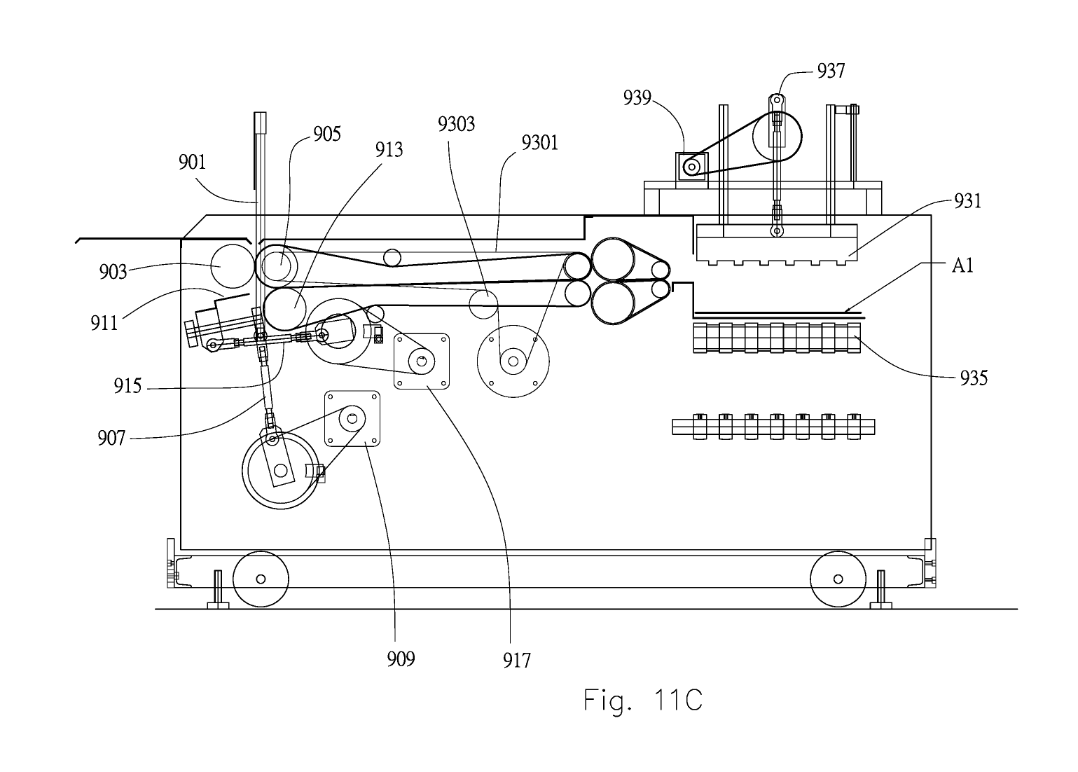

Referring also to FIGS. 1B and 11A-11C, the uninterrupted bag making and folding machine further comprises a folding unit 90 adapted for folding up individual finished bags A3 after breaking from respective perforated portions A1 of the film tube A to reduce the size for storage and delivery.

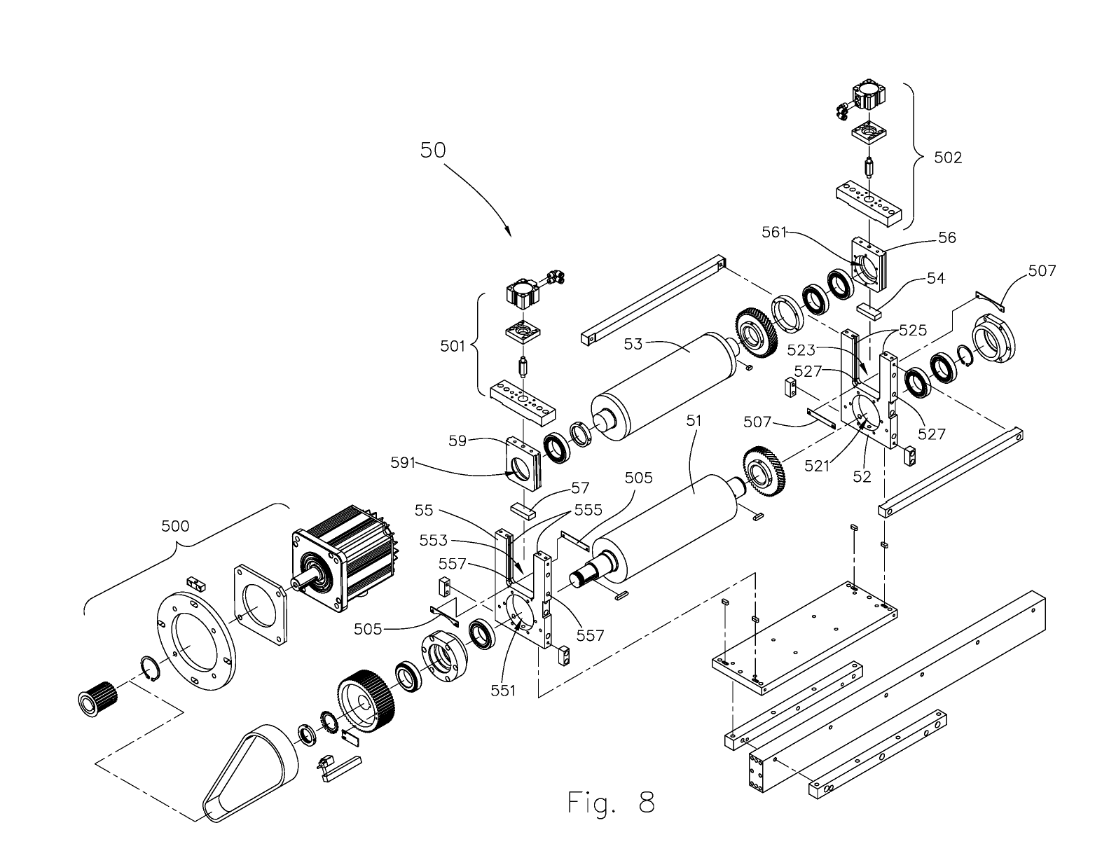

Referring to FIGS. 1-10, the film tube A is being transferred through the conveyer rollers of the conveyance unit 10, the position sensing unit 13, the reciprocating conveyer 31 of the sealing unit 30, the third nip roller set 40, the perforating unit 50 and the breaking unit 70 to the folding unit 90 to complete all processes.

In the operation of the uninterrupted bag making and folding machine, a control unit (not shown) controls the reciprocating server power source 319 of the sealing unit 30 to drive the transmission means 317 forward or backward. The reciprocating server power source 319, for example, servo motor rotates forward to move the transmission means 317, causing the transmission means 317 to move the sliding block 313 and the reciprocating wheel 315 to carry the film tube A forward at a speed synchronous to the speed of the first server power source 35 or the second server power source 37. At the same time, the upper sealing assembly server power source 38 drives the upper sealing assembly 32 to thermally press the film tube A onto the lower sealing assembly 33, thereby sealing the film tube A. Thereafter, the upper sealing assembly server power source 38 drives the upper sealing assembly 32 to move backward, and the reciprocating server power source 319 (servo motor) is rotated to move the transmission means 317 in the reversed direction, returning the sliding blocks 313 and the reciprocating wheels 315 to their previous positions, completing a film tube A sealing process. This action is repeated again and again.

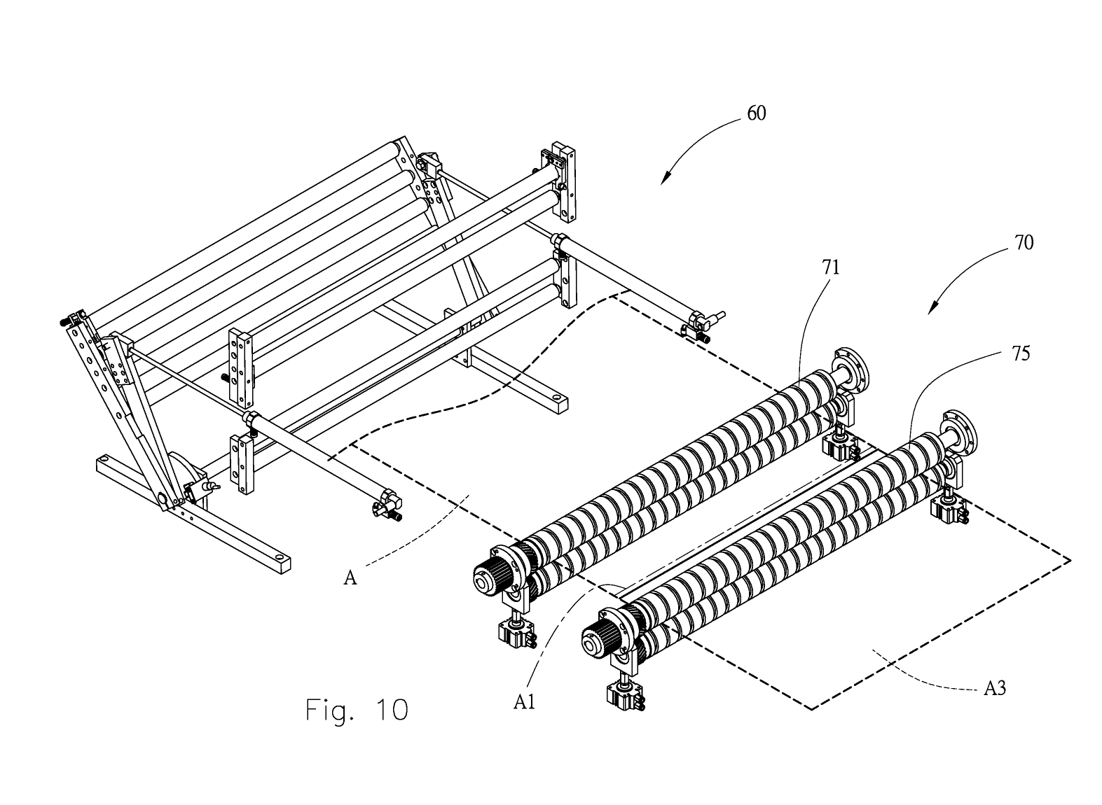

Further, the control unit (not shown) is electrically coupled with the position sensing unit, the first server power source 35, the second server power source 37, the upper sealing assembly server power source 38, the reciprocating server power source 319, the third server power source 41, the perforating unit 50, the breaking unit 70 and the folding unit 90, and adapted for instructing the aforesaid various processing units to cooperate with each other. The moving direction and speed of the film tube A are constant. The rotating speed of the roller die cutter of the perforating unit 50 is constant. Thus, the film tube A can be delivered smoothly and properly treated through a sealing process, a waste breaking process, and a folding process. In the waste breaking process, a waste breaking mechanism, for example, air jet device is operated to break the waste from the film tube. Thereafter, the breaking unit 70 (see FIG. 10B) is controlled to break each perforated portion A1 of the film tube A, and each finished bag A3 thus obtained is folded up by the folding unit 90. The aforesaid various processing processed are continuously performed, accelerating the finished bag fabrication speed and improving the production capacity.

The aforesaid conveyance unit 10 further comprises a feed wheel 101, a movable rack 103, a speed control wheel 105, and a speed control wheel power source 107. The feed wheel 101 has the film tube A rolled up thereon. The speed control wheel 105 and the speed control wheel power source 107 are mounted at one side of the movable rack 103. The speed control wheel power source 107 is adapted for controlling the rotating speed of the speed control wheel 105. Thus, the movable rack 103 can be moved to carry the speed control wheel 105 into abutment against the feed wheel 101, controlling the speed of the feed wheel 101 in feeding the film tube A.

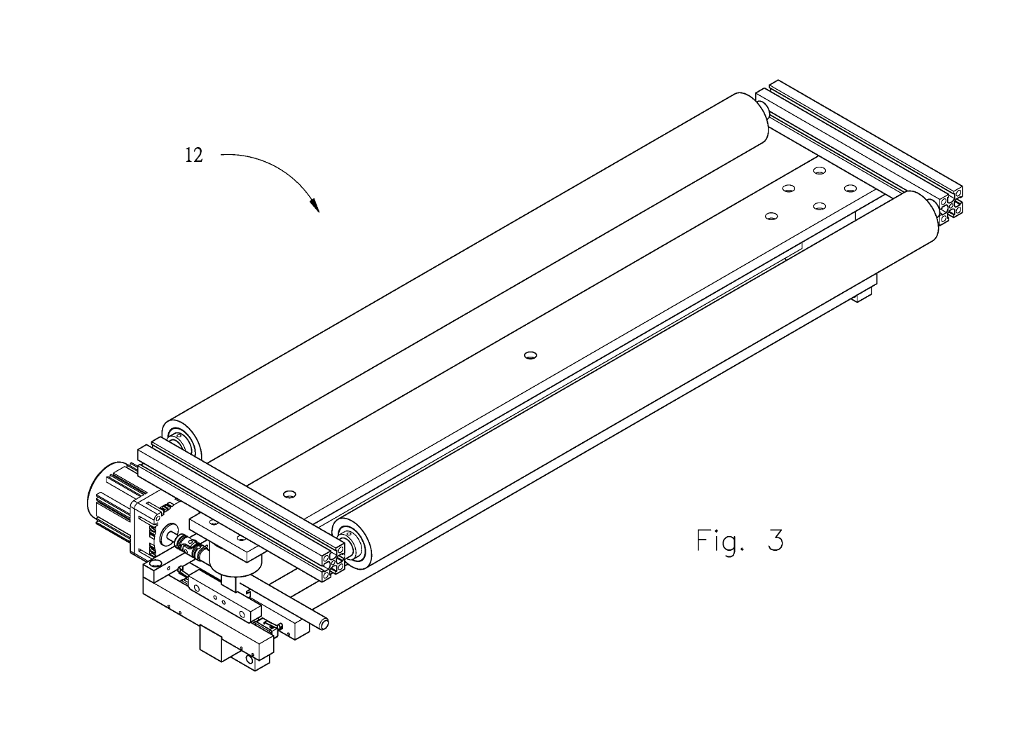

Referring also to FIG. 3, the uninterrupted bag making and folding machine further comprises a first side guide device 12 disposed between the conveyance unit 10 and the position sensing unit 13 for the passing of the film tube A therethrough to adjust the output direction of the film tube A, avoiding deviation.

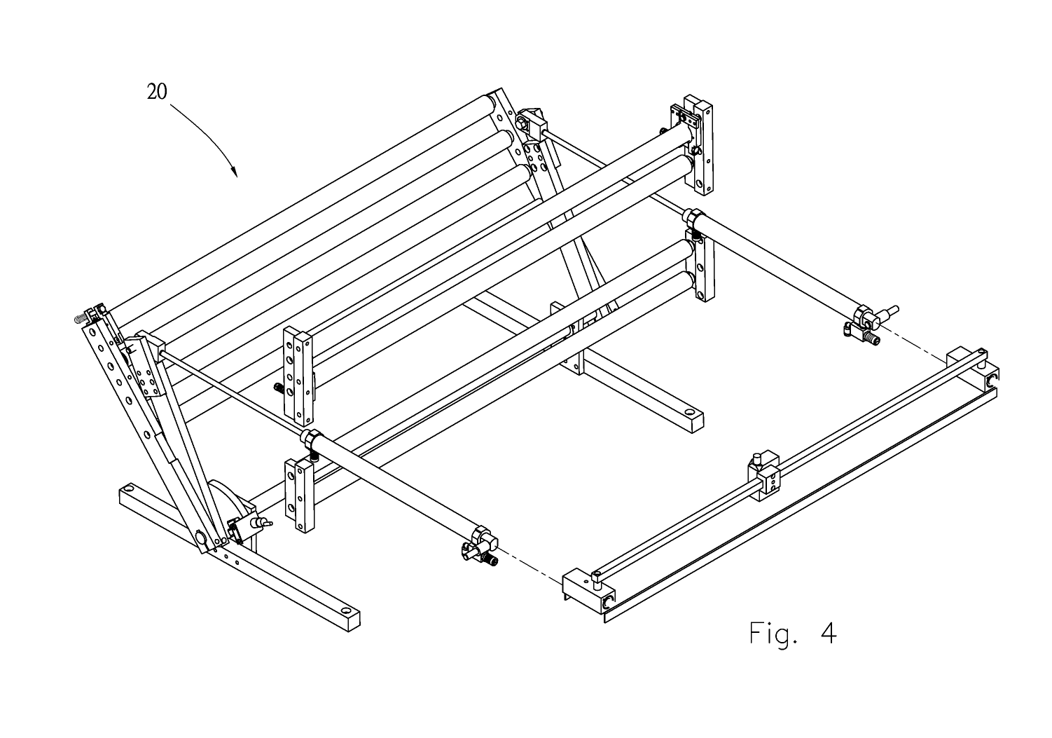

Referring also to FIG. 4, the uninterrupted bag making and folding machine further comprises a first film tube tensioner 20 disposed between the position sensing unit 13 and the sealing unit 30 for the passing of the film tube A therethrough to maintain the tension of the film tube A.

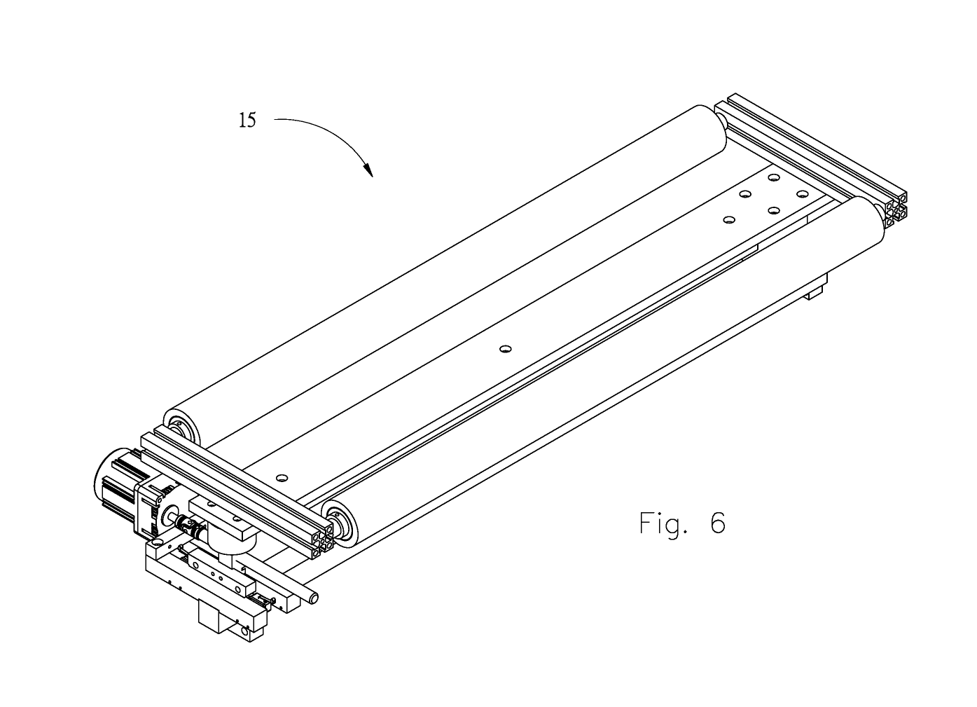

Referring also to FIG. 6, the uninterrupted bag making and folding machine further comprises a second side guide device 15 disposed between the sealing unit 30 and the third nip roller set 40 for the passing of the film tube A therethrough to adjust the output direction of the film tube A, avoiding deviation.

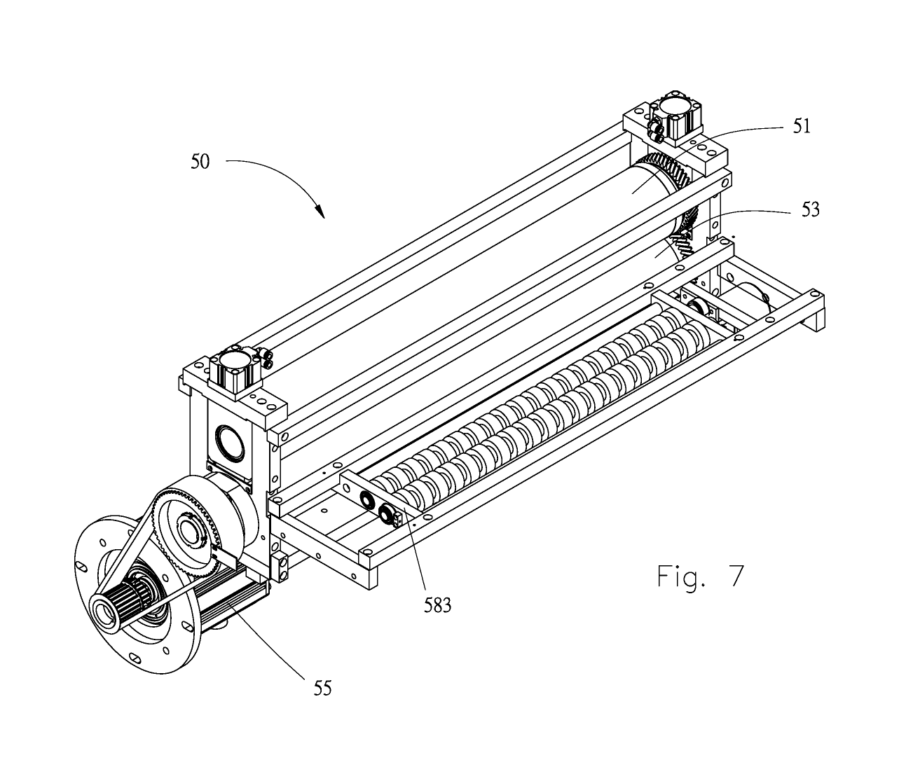

Referring also to FIGS. 1B and 7, the uninterrupted bag making and folding machine further comprises a waste breaking device 58 arranged downstream of the perforating unit 50 below the film tube A. The waste breaking device 58 comprises a jet blower 581, a set of waste rollers 583, and a waste roller power source 585. The waste rollers 583 are rotatably meshed together. The waste roller power source 585 is adapted for rotating the waste rollers 58. The jet blower 581 is disposed above the waste rollers 583 for blowing a jet of air toward the area between a waste breaking portion (for example, a perforated portion) of the film tube A and the set of waste rollers 583, enabling the waste rollers 583 to seize the waste and to carry the waste downward.

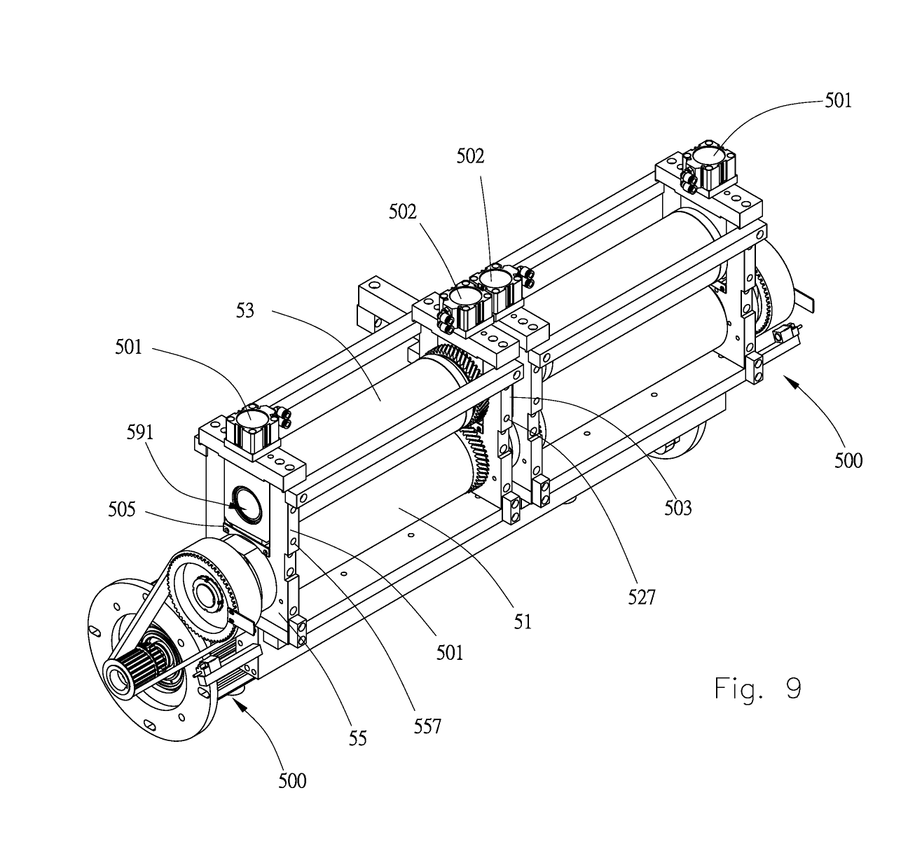

Referring also to FIGS. 1A, 1B, 5 and 7-10, the perforating unit 50 comprises a roller 51 and a roller die cutter 53. The roller die cutter 53 is rotatably abutted against the roller 51. Further, a fourth server power source 500 is coupled to the roller 51 for rotating the roller die cutter 53. The roller die cutter 51 has a breaking knife pattern. The film tube A is inserted through the roller 51 and the roller die cutter 53, and processed to create perforated portions thereon for making a perforated portion A1 on the film tube A at every predetermined distance (see FIG. 10). In one embodiment of the present invention, as illustrated in FIG. 9, two perforating units 50 are provided.

The perforating unit 50 further comprises a first bearing block 55, a first slider 57, a first adjustment block 59, a second bearing block 52, a second slider 54, and a second adjustment block 56.

The first bearing block 55 comprises a first axle hole 551 located near a bottom side thereof, a first slot 553 spaced above the first axle hole 551, and two first rails 555 vertically disposed at two opposite lateral sides of the first slot 553. The first slider 57 is mounted at a bottom side of the first slot 553. The first adjustment block 59 is movably coupled between the first rails 555 with a beveled bottom surface thereof kept in contact with the first slider 57, comprising a second axle hole 591. The roller die cutter 53 has one end thereof rotatably coupled to the second axle hole 591. The roller 51 of the perforating unit 50 has one end thereof rotatably coupled to the first axle hole 551.

Correspondingly, the second bearing block 52 further comprises a third axle hole 521 located near a bottom side thereof, a second slot 523 spaced above the third axle hole 521, and two second rails 525 vertically disposed at two opposite lateral sides of the second slot 523. The second slider 54 is mounted at a bottom side of the second slot 523. The second adjustment block 56 is movably coupled between the second rails 525 with a beveled bottom surface thereof kept in contact with the second slider 54, comprising a fourth axle hole 561. The roller die cutter 53 has an opposite end thereof rotatably coupled to the fourth axle hole 561. The roller 51 has an opposite end thereof rotatably coupled to the third axle hole 521.

The first slider 57 is movable in the bottom side of the first slot 553 along the beveled bottom surface of the first adjustment block 59, forcing the first adjustment block 59 to adjust the elevation of one end of the roller die cutter 53. The second slider 54 is movable in the bottom side of the second slot 523 along the beveled bottom surface of the second adjustment block 56, forcing the second adjustment block 56 to adjust the elevation of an opposite side of the roller die cutter 53. Thus, the roller die cutter 53 can be fine-adjusted relative to the roller 51 according to the thickness of the film tube A that is inserted through the gap between the roller die cutter 53 and the roller 51 for processing to form a perforated portion A1 thereon.

The perforating unit 50 further comprises a first pneumatic cylinder 501 and a second pneumatic cylinder 502. The first pneumatic cylinder 501 is mounted at a top side of the first bearing block 55 for moving the first adjustment block 59 in the first slot 553 upward or downward along the first rails 555 to lift or lower one end of the roller die cutter 53.

The second pneumatic cylinder 502 is mounted at a top side of the second bearing block 52 for moving the second adjustment block 56 in the first slot 553 upward or downward along the second rails 525 to lift or lower the other end of the roller die cutter 53.

Thus, when the roller die cutter 53 is pulled away from the roller 51, the operator can replace the film tube A or die cutter. On the contrary, when the roller die cutter 53 is set into position in proximity to the roller 51, a perforated portion processing process can then be performed.

The perforating unit 50 further comprises a set of first bumper plates 505 and a set of second bumper plates 507. The set of first bumper plates 505 is adapted to keep the first slider 57 in the first slot 553, presenting the first slider 57 from falling out of the first slot 553. The set of second bumper plates 507 is adapted to keep the second slider 54 in the second slot 523, preventing the second slider 54 from falling out of the second slot 523.

The first bearing block 55 further comprises a set of first through holes 557 extended across the first slot 553. The second bearing block 52 further comprises a set of second through holes 527 extended across the second slot 523.

Thus, screws are respectively inserted through the set of first through holes 557 to adjust the position of the first slider 57 in the first slot 553 in abutment against the beveled bottom surface of the first adjustment block 59, achieving adjustment of the elevation of the first adjustment block 59 and the respective end of the roller die cutter 53. Similarly, screws are respectively inserted through the set of second through holes 527 to adjust the position of the second slider 54 in the second slot 523 in abutment against the beveled bottom surface of the second adjustment block 56, achieving adjustment of the elevation of the second adjustment block 56 and the respective end of the roller die cutter 53.

Referring to FIG. 10, a second film tube tensioner 60 is disposed between the perforating unit 50 and the breaking unit 70.

Referring also to FIGS. 1B and 10, the breaking unit 70 comprises a first pull-off wheel set 71, a fifth server power source 73, a second pull-off wheel set 75, and a sixth server power source 77. The fifth server power source 73 is adapted for driving the first pull-off wheel set 71 to rotate. The second pull-off wheel set 75 is disposed upstream of the first pull-off wheel set 71. The sixth server power source 77 is adapted for driving the second pull-off wheel set 75 to rotate. The sixth server power source 77 and the second pull-off wheel set 75 are controllable to rotate at a predetermined moment relatively faster than the fifth server power source 73 and the first pull-off wheel set 71. When one perforated portion A1 of the film tube A reaches a point between the first pull-off wheel set 73 and the second pull-off wheel set 75, the control unit instructs the sixth server power source 77 to rotate the second pull-off wheel set 75 at a speed relatively faster than the first pull-off wheel set 71, or, the control unit instructs the fifth server power source 73 to rotate the first pull-off wheel set 71 at a speed relatively slower than the second pull-off wheel set 75, enabling the perforated portion A1 to be broken, and thus, a finished bag A3 is obtained.

Referring to FIGS. 11-13, the folding unit 90 comprises a first folding blade 901, a first folding wheel 903, a secondary folding wheel 905, a first folding blade linkage 907 and a first folding blade server power source 909. The first folding wheel 903 is rotatably abutted against the secondary folding wheel 905. The first folding blade 901 is vertically movably disposed above the first folding wheel 903 and the secondary folding wheel 905. The first folding blade linkage 907 has one end thereof rotatably coupled to the first folding blade 901, and an opposite end thereof rotatably coupled to the first folding blade server power source 909. When the finished bag A3 is delivered by the conveyer rollers to a top side of the first folding wheel 903 and a top side of the secondary folding wheel 905, the control unit instructs the first folding blade server power source 909 to move the first folding blade 901 downward, forcing the finished bag A3 in between the first folding wheel 903 and the secondary folding wheel 905.

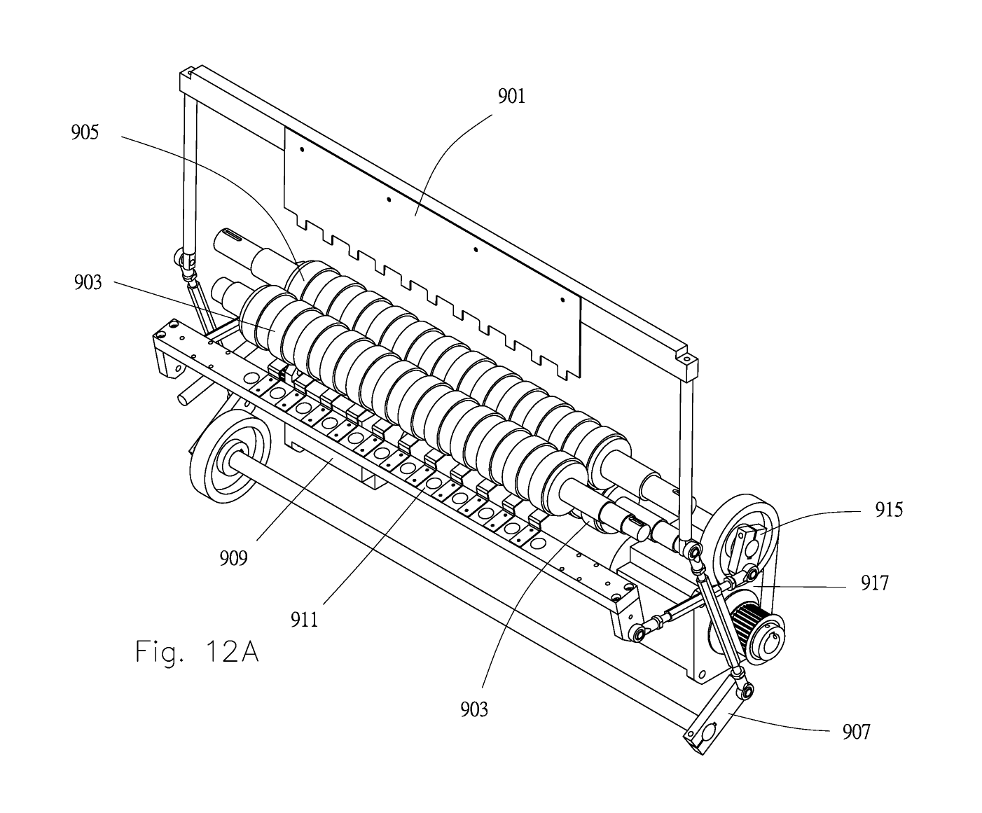

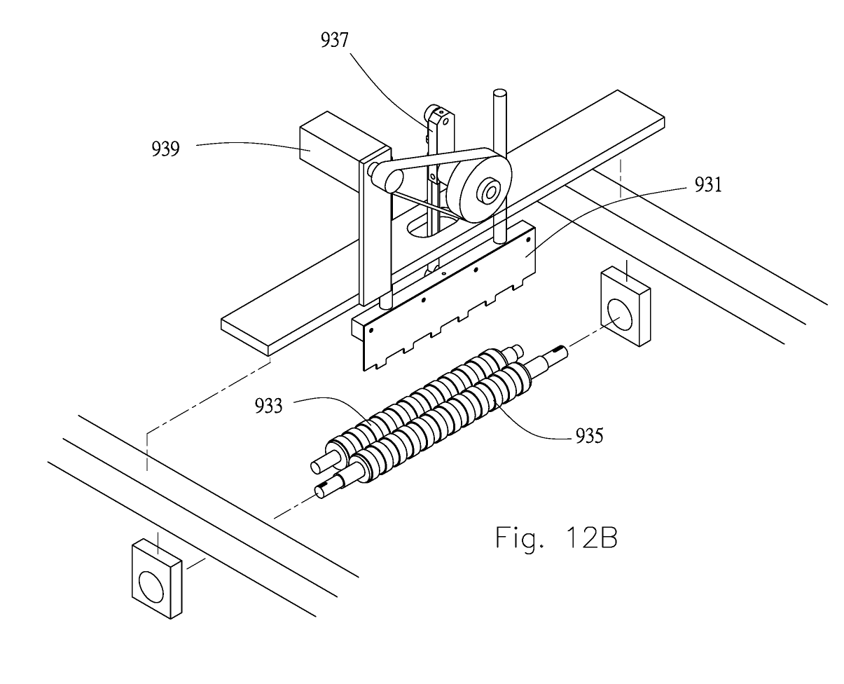

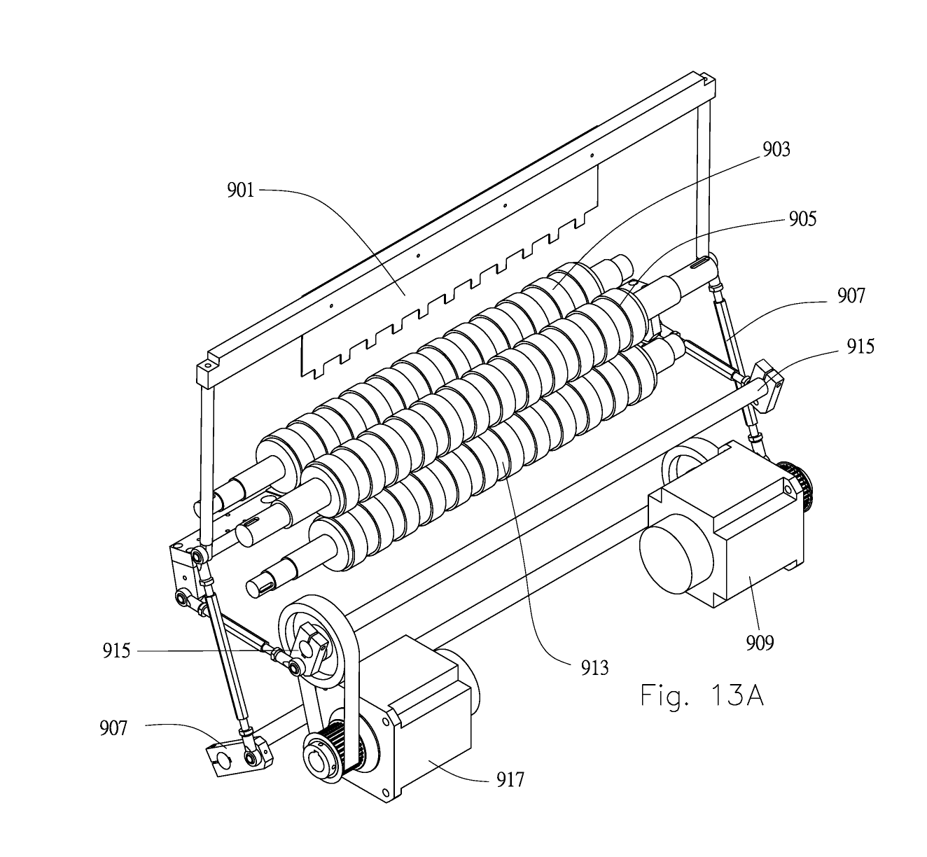

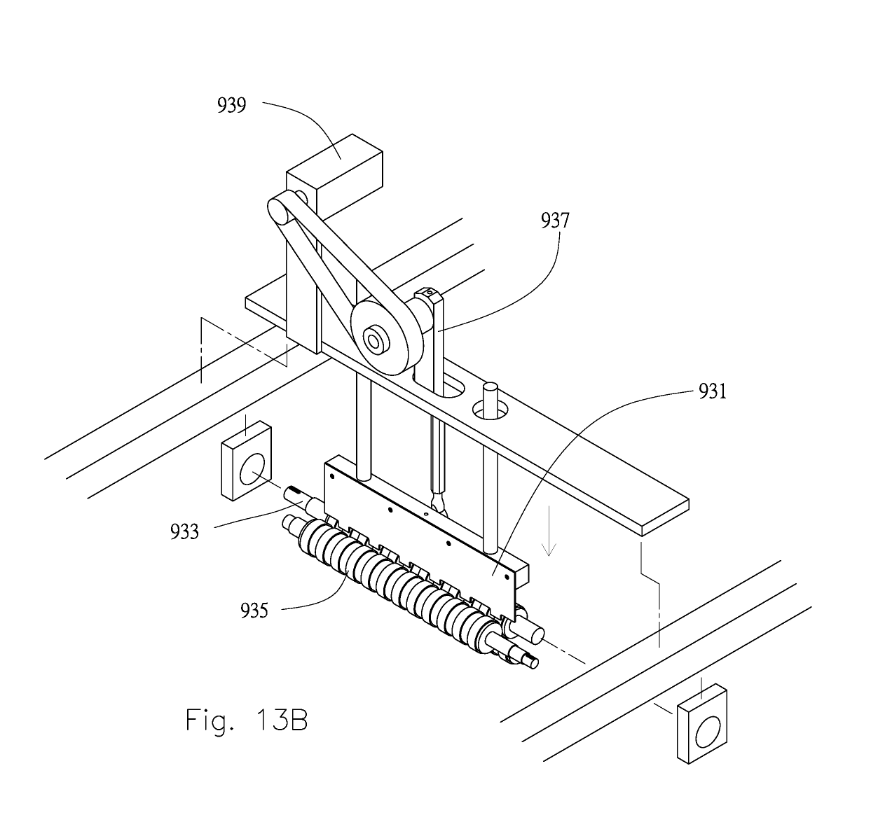

Referring to FIGS. 12A and 13A, the folding unit 90 further comprises a second folding blade 911, a third folding wheel 913, a second folding blade linkage 915 and a second folding blade server power source 917. The third folding wheel 913 is rotatably abutted against a bottom side of the secondary folding wheel 905. The second folding blade 911 is vertically disposed at one side relative to the third folding wheel 913 and the secondary folding wheel 905 and movable leftward and rightward. The second folding blade 911 is movable in a direction perpendicular to the first folding blade 901. The second folding blade linkage 915 has one end thereof rotatably coupled to the second folding blade 911, and an opposite end thereof rotatably coupled to the second folding blade server power source 917. When the finished bag A3 is pushed by the first folding blade 901 to one side of the secondary folding wheel 905 and one side of the third folding wheel 913, the control unit instructs the second folding blade server power source 917 to move the second folding blade 911 to force the finished bag A3 in between the secondary folding wheel 905 and the third folding wheel 913.

The folding unit 90 further comprises a first runner 9300, a first conveyer belt 9301 rotatably coupled between the first runner 9300 and the secondary folding wheel 905, a second runner 9302 rotatably abutted against the first runner 9300, a second conveyer belt 9303 rotatably coupled between the second runner 9302 and the third folding wheel 913, a power drive 9305 rotatably connected with the first runner 9300 and/or the secondary folding wheel 905, and electrically connected to the control unit. In the secondary folding operation, the finished bag A3 is forced in between the first conveyer belt 9301 that is rotatable by the secondary folding wheel 905 and the second conveyer belt 9303 that is rotatable by the third folding wheel 913, and then carried forward by the first conveyer belt 9301 and the second conveyer belt 9303 for a next processing process.

Referring to FIGS. 12B and 13B, the folding unit 90 further comprises a third folding blade 931, a fourth folding wheel 933, a fifth folding wheel 935, a third folding blade linkage 937 and a third folding blade server power source 939. The fourth folding wheel 933 is rotatably abutted against the fifth folding wheel 935. The third folding blade 931 vertically movable disposed above the fourth folding wheel 933 and the fifth folding wheel 935. The moving direction of the third folding blade 931 is perpendicular to the second folding blade 911. The third folding blade linkage 937 has one end thereof rotatably coupled to the third folding blade 931, and an opposite end thereof rotatably coupled to the third folding blade server power source 939. Thus, the third folding blade 931 can be moved downwardly into the space between the fourth folding wheel 933 and the fifth folding wheel 935 to fold up the finished bag A3 at a third time. Thereafter, the third folding blade is returned to its previous position for a next folding action.

In the secondary folding operation, the finished bag A3 is secured in between the first conveyer belt 9301 that is movable by the secondary folding wheel 905 and the second conveyer belt 9303 that is movable by the third folding wheel 913. The control unit instructs the power drive 9305 to rotate the first runner 9300 in carrying the first conveyer belt 9301 and the secondary folding wheel 905. The rotation of the first runner 9300 causes the second runner 9302, the second conveyer belt 9303 and the third folding wheel 913 to deliver the finished bag A3 to the top side of the fourth folding wheel 933 and the top side of the fifth folding wheel 935. Thereafter, the control unit instructs the third folding blade server power source 939 to move the third folding blade 931 downward, forcing the finished bag A3 in between the fourth folding wheel 933 and the fifth folding wheel 935 to complete the third folding operation.

The control unit is electrically coupled with the speed control wheel power source 107, the position sensing unit 13, the reciprocating server power source 319, the first server power source 35, the second server power source 37, the upper sealing assembly server power source 38, the third server power source 41, the fourth server power source 500, jet blower 581 and waste roller power source 585 of the perforating unit 50, the fifth server power source 73 and sixth server power source 77 of the breaking unit 70 and the first folding blade server power source 909, second folding blade server power source 917, third folding blade server power source 939 and power drive 9305 of the folding unit 90. Thus, the control unit can control the aforesaid various units to cooperate with one another, enabling the film tube A to be moved in the predetermined direction at a constant speed relative to the roller die cutter 53 of the perforating unit 50 and properly treated through the sealing process and the waste breaking process. In the waste breaking process, the waste breaking device 58, for example, air jet device imparts an air pressure to break the waste off the film tube, enabling the film tube to be separated into individual finished bags through each perforated portion and separated individual finished bags to be properly folded up. Thus, the fabrication and folding of finished bags can be done rapidly in a continuous manner, increasing the production capacity.

Further, the server power source in accordance with the present invention can be a motor or servo motor.

Although the present invention has been described with a certain degree of particularity, it is understood that the present disclosure is made by way of example only and the combination and arrangement of parts may be resorted to without departing from the spirit and scope of the invention hereinafter claimed.

What the invention claimed is:

1. An uninterrupted bag making and folding machine, comprising:
a conveyance unit for conveying a film tube;
a plurality of conveyer rollers arranged over the uninterrupted bag making and folding machine to assist conveyance of a film tube for processing;
a position sensing unit disposed downstream of said conveyance unit for detecting the travel distance of said film tube to mate with a predetermined process distance;
a sealing unit disposed downstream of said position sensing unit, said sealing unit comprising a reciprocating conveyer, an upper sealing assembly, a lower sealing assembly, a first nip roller set, a first server power source, a second nip roller set, a second server power source, an upper sealing assembly server power source and a heating unit, said first server power source being adapted for moving said first nip roller set, said second server power source being adapted for moving said second nip roller set, said upper sealing assembly server power source being adapted for moving said upper sealing assembly up and down, said heating unit being adapted for heating said upper sealing assembly and/or said lower sealing assembly, said reciprocating conveyer comprising a pair of rails arranged in parallel and a pair of sliding blocks arranged in parallel and respectively and slidably coupled to said rails;
a pair of reciprocating wheels arranged in parallel and respectively rotatably coupled to said sliding blocks for enabling said film tube to be delivered above said reciprocating wheels, said reciprocating wheels being disposed below said upper sealing assembly and above said lower sealing assembly;
a transmission means;
a reciprocating server power source for driving said transmission means to move said sliding block and said reciprocating wheel forward or backward;
a third nip roller set;
a third server power source disposed downstream of said sealing unit and adapted for rotating said third nip roller set;
a perforating unit disposed downstream of said third nip roller set and adapted for processing said film tube to form a perforated portion thereon; and
a breaking unit disposed downstream of said film tube for breaking said perforated portion to obtain a finished bag.

2. The uninterrupted bag making and folding machine as claimed in claim 1, further comprising a waste breaking device disposed downstream of said perforating unit below said film tube, said waste breaking device comprising a jet blower, a set of waste rollers and a waste roller power source, said jet blower being disposed above said set of waste rollers, said set of waste rollers being rotatably meshed together, said waste roller power source being adapted for rotating the meshed said waste rollers.

3. The uninterrupted bag making and folding machine as claimed in claim 1, wherein said perforating unit comprises a roller, a roller die cutter rotatably abutted against said roller and a fourth server power source coupled with said roller and adapted for rotating said roller and then said roller die cutter, said roller die cutter comprising a breaking knife pattern and being so arranged that said film tube movable in between said roller and said roller die cutter and processed by said roller die cutter to create a perforated portion thereon.

4. The uninterrupted bag making and folding machine as claimed in claim 3, wherein said perforating unit further comprises a first bearing block, a first slider, a first adjustment block, a first bearing block, a second slider, a second adjustment block, said first bearing block comprising a first axle hole located near a bottom side thereof, a first slot spaced above said first axle hole and two first rails vertically disposed at two opposite lateral sides of said first slot, said first slider being mounted at a bottom side of said first slot, said first adjustment block being movably coupled between said first rails with a beveled bottom surface thereof kept in contact with said first slider, said first adjustment block comprising a second axle hole, said roller die cutter having one end thereof rotatably coupled to said second axle hole, said first axle hole being coupled with one end of said roller of said perforating unit for allowing said roller to rotate therein, said second bearing block comprising a third axle hole located near a bottom side thereof, a second slot spaced above said third axle hole and two second rails vertically disposed at two opposite lateral sides of said second slot, said second slider being mounted at a bottom side of said second slot, said second adjustment block being movably coupled between said second rails with a beveled bottom surface thereof kept in contact with said second slider, said second adjustment block comprising a fourth axle hole coupled with an opposite end of said roller die cutter for allowing said roller die cutter to rotate therein, said third axle hole being coupled with an opposite end of said roller for allowing said roller to rotate therein,

5. The uninterrupted bag making and folding machine as claimed in claim 4, wherein said perforating unit further comprises a first pneumatic cylinder and a second pneumatic cylinder, said first pneumatic cylinder being mounted at a top side of said first bearing block and adapted for moving said first adjustment block in said first slot upward or downward along said first rails to lift or lower one end of said roller die cutter, said second pneumatic cylinder being mounted at a top side of said second bearing block and adapted for moving said second adjustment block in said first slot upward or downward along said second rails to lift or lower the opposite end of said roller die cutter

6. The uninterrupted bag making and folding machine as claimed in claim 5, wherein said perforating unit further comprises a set of first bumper plates and a set of second bumper plates, said set of first bumper plates being adapted to keep said first slider in said first slot, said set of second bumper plates being adapted to keep said second slider in said second slot.

7. The uninterrupted bag making and folding machine as claimed in claim 6, wherein said first bearing block further comprises a set of first through holes extended across said first slot; said second bearing block further comprises set of second through holes extended across said second slot.

8. The uninterrupted bag making and folding machine as claimed in claim 7, wherein said breaking unit further comprises a first pull-off wheel set, a fifth server power source, a second pull-off wheel set and a sixth server power source, said fifth server power source being adapted for rotating said first pull-off wheel set, said second pull-off wheel set being disposed downstream of said first pull-off wheel set, said sixth server power source being adapted for rotating said second pull-off wheel set, said sixth server power source and said second pull-off wheel set being controllable to rotate at a predetermined moment at a faster speed than said fifth server power source and said first pull-off wheel set.

9. The uninterrupted bag making and folding machine as claimed in claim 8, further comprising a folding unit, said folding unit comprising a first folding blade, a first folding wheel, a secondary folding wheel, a first folding blade linkage and a first folding blade server power source, said first folding wheel being rotatably abutted against said secondary folding wheel, said first folding blade being vertically movable disposed above said first folding wheel and said secondary folding wheel, said first folding blade linkage having one end thereof rotatably coupled to said first folding blade and an opposite end thereof rotatably coupled to said first folding blade server power source.

10. The uninterrupted bag making and folding machine as claimed in claim 9, wherein said folding unit further comprises a second folding blade, a third folding wheel, second folding blade linkage and a second folding blade server power source, said third folding wheel being rotatably abutted against said secondary folding wheel, said second folding blade being movably disposed at one side relative to said third folding wheel and secondary folding wheel in a movable manner, said second folding blade being movable in a direction perpendicular to said first folding blade, said second folding blade linkage having one end thereof rotatably coupled to said second folding blade and an opposite end thereof rotatably coupled to said second folding blade server power source.

11. The uninterrupted bag making and folding machine as claimed in claim 10, wherein said folding unit further comprises a first runner, a first conveyer belt, a second runner, a second conveyer belt and a power drive for performing a secondary finished bag folding operation, said first conveyer belt being rotatably coupled between said first runner and said secondary folding wheel, said second runner being rotatably abutted against said first runner, said second conveyer belt being rotatably coupled between said second runner and said third folding wheel, said power drive being adapted for rotating said first runner and/or said secondary folding wheel and electrically coupled to said control unit, said secondary folding operation being performed in such a manner that said finished bag is forced in between said first conveyer belt that is rotatable by said secondary folding wheel and said second conveyer belt that is rotatable by said third folding wheel, and then carried forward by said first conveyer belt and said second conveyer belt for a next processing process.

12. The uninterrupted bag making and folding machine as claimed in claim 11, wherein said folding unit further comprises a third folding blade, a fourth folding wheel, a fifth folding wheel, a third folding blade linkage and a third folding blade server power source, said fourth folding wheel being rotatably abutted against said fifth folding wheel, said third folding blade being vertically movably disposed above said fourth folding wheel and said fifth folding wheel, said third folding blade being movable in a direction perpendicular to said second folding blade, said third folding blade linkage having one end thereof rotatably coupled to said third folding blade and an opposite end thereof rotatably coupled to said third folding blade server power source.

13. The uninterrupted bag making and folding machine as claimed in claim 12, wherein said control unit is electrically coupled with said speed control wheel power source, said position sensing unit, said reciprocating server power source, said first server power source, said second server power source, said upper sealing assembly server power source, said third server power source, the said fourth server power source and said jet blower and said waste roller power source of said perforating unit, the said fifth server power source and sixth server power source of said breaking unit and the said first folding blade server power source, said second folding blade server power source, said third folding blade server power source and said power drive of said folding unit, so that said control unit is capable of controlling the component parts that are electrically coupled thereto to cooperate with one another, enabling said film tube to be moved in the predetermined direction at a constant speed relative to said roller die cutter of said perforating unit and properly treated through a sealing process and a waste breaking process where said waste breaking device imparts an air pressure to break the waste off said film tube for enabling an individual finished bag to be separated from the rest of said film tube through said perforated portion and then properly folded up.

14. The uninterrupted bag making and folding machine as claimed in claim 1, wherein said conveyance unit further comprises a feed wheel, a movable rack, a speed control wheel and a speed control wheel power source, said feed wheel being adapted to roll up said film tube, said speed control wheel and said speed control wheel power source being mounted at one side of said movable rack, said speed control wheel power source being adapted for controlling the rotating speed of said speed control wheel.

15. The uninterrupted bag making and folding machine as claimed in claim 1, further comprising a first side guide device disposed between said conveyance unit and said position sensing unit.

16. The uninterrupted bag making and folding machine as claimed in claim 1, further comprising a first film tube tensioner disposed between said position sensing unit and said sealing unit.

17. The uninterrupted bag making and folding machine as claimed in claim 1, further comprising a folding unit, said folding unit comprising a first folding blade, a first folding wheel, a secondary folding wheel, a first folding blade linkage and a first folding blade server power source, said first folding wheel being rotatably abutted against said secondary folding wheel, said first folding blade being vertically movable disposed above said first folding wheel and said secondary folding wheel, said first folding blade linkage having one end thereof rotatably coupled to said first folding blade and an opposite end thereof rotatably coupled to said first folding blade server power source.

18. The uninterrupted bag making and folding machine as claimed in claim 17, wherein said folding unit further comprises a second folding blade, a third folding wheel, second folding blade linkage and a second folding blade server power source, said third folding wheel being rotatably abutted against said secondary folding wheel, said second folding blade being movably disposed at one side relative to said third folding wheel and secondary folding wheel in a movable manner, said second folding blade being movable in a direction perpendicular to said first folding blade, said second folding blade linkage having one end thereof rotatably coupled to said second folding blade and an opposite end thereof rotatably coupled to said second folding blade server power source.

19. The uninterrupted bag making and folding machine as claimed in claim 18, wherein said folding unit further comprises a first runner, a first conveyer belt, a second runner, a second conveyer belt and a power drive for performing a secondary finished bag folding operation, said first conveyer belt being rotatably coupled between said first runner and said secondary folding wheel, said second runner being rotatably abutted against said first runner, said second conveyer belt being rotatably coupled between said second runner and said third folding wheel, said power drive being adapted for rotating said first runner and/or said secondary folding wheel and electrically coupled to said control unit, said secondary folding operation being performed in such a manner that said finished bag is forced in between said first conveyer belt that is rotatable by said secondary folding wheel and said second conveyer belt that is rotatable by said third folding wheel, and then carried forward by said first conveyer belt and said second conveyer belt for a next processing process.

20. The uninterrupted bag making and folding machine as claimed in claim 19, wherein said folding unit further comprises a third folding blade, a fourth folding wheel, a fifth folding wheel, a third folding blade linkage and a third folding blade server power source, said fourth folding wheel being rotatably abutted against said fifth folding wheel, said third folding blade being vertically movably disposed above said fourth folding wheel and said fifth folding wheel, said third folding blade being movable in a direction perpendicular to said second folding blade, said third folding blade linkage having one end thereof rotatably coupled to said third folding blade and an opposite end thereof rotatably coupled to said third folding blade server power source.
